(19) United States
(12) Patent Application Publication
(10) Pub. No.: US 2023/0056964 A1
(43) Pub. Date: Feb. 23, 2023

(54) POWER LIMITS BASED ON PROCESSOR THROTTLING

(71) Applicant: HEWLETT-PACKARD DEVELOPMENT COMPANY, L.P., Spring, TX (US)

(72) Inventors: Brian Christopher MAYER, Boise, ID (US); Michael Ray RIPPEE, Boise, ID (US)

(21) Appl. No.: 17/408,994

(22) Filed: Aug. 23, 2021

(51) Int. Cl. G03G 15/20; G03G 15/00

(52) U.S. Cl. CPC G03G 15/201; G03G 15/5045; G03G 15/505

(57) ABSTRACT

An example device includes: a print engine including a fuser; an ambient temperature sensor; a memory storing a plurality of curves that relate, for given respective ambient temperatures, respective time periods for the fuser to heat to a fusing temperature, to respective factors associated with cooling of the fuser; and a processor The processor is to: detect a current ambient temperature using the ambient temperature sensor; select a curve, from the plurality of curves, using the current ambient temperature; determine a current factor associated with cooling of the fuser; and control the fuser to heat to the fusing temperature based on a respective time period determined from the curve and the current factor associated with cooling of the fuser.

### BACKGROUND

When fusers, and other components of print engines, for example of laser printers, are controlled to prepare for printing too early, undue wear and tear may occur on the components. Similarly, when fusers, etc., of the print engines are controlled to prepare for printing too late there may be undue delay in printing.

### BRIEF DESCRIPTION OF THE DRAWINGS

Reference will now be made, by way of example only, to the accompanying drawings in which:

FIG. 1 is a block diagram of an example device to control a print engine based on ambient temperatures.

FIG. 2 is a block diagram of another example device to control a print engine based on ambient temperatures.

FIG. 3 is an example timing diagram of a scan engine and a print engine.

FIG. 4 is an example curve that relates, for a given respective ambient temperature, respective times for a fuser of a print engine to heat to a fusing temperature, to a respective factor associated with cooling of the fuser.

FIG. 5 is a flow diagram of an example method to control a print engine based on ambient temperatures.

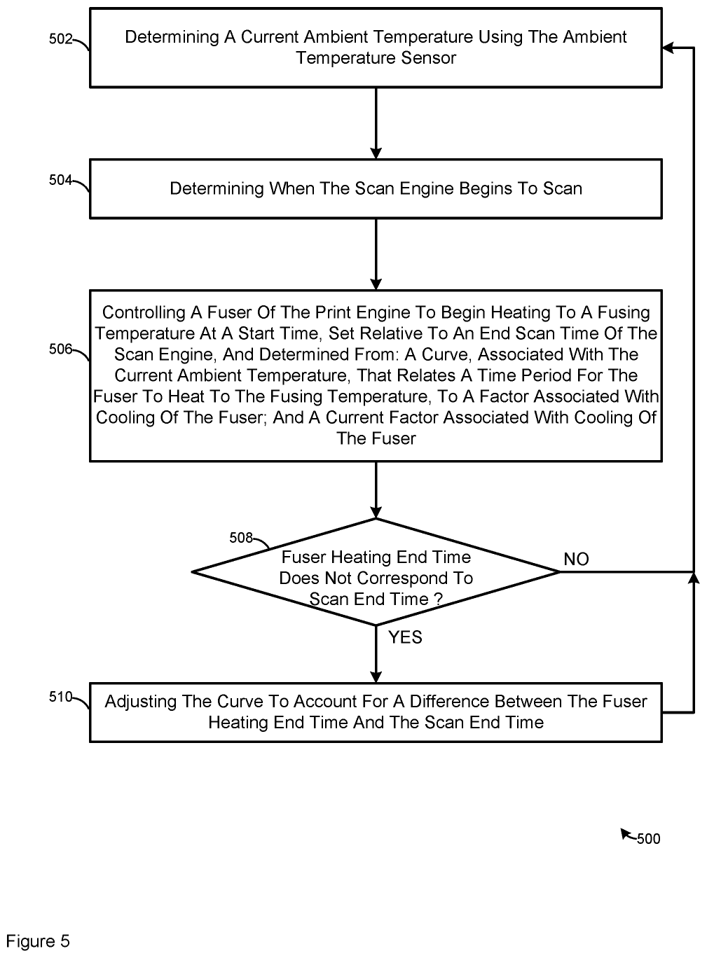

FIG. 6 is a block diagram of an example computer-readable medium including instructions that causes a processor to control a print engine based on ambient temperatures.

### DETAILED DESCRIPTION

When fusers, and other components of print engines, for example of laser printers, are controlled to prepare for printing too early, undue wear and tear may occur on the components. Similarly, when fusers, etc., of the print engines are controlled to prepare for printing too late there may be undue delay in printing. Time periods for the fusers, etc., of the print engines to prepare for printing may vary with ambient temperature.

Provided herein is a device, such as a laser printer device, that includes a print engine with a fuser. The print engine is generally to receive and print a print job (e.g., images thereof). In some examples, the device may further include a scan engine that generated the print job. The device is generally configured to coordinate controlling the fuser to heat to a fusing temperature with a scan end time of the scanning engine such that, when the scan engine has completed scanning, the fuser, and the print engine, are ready to print the print job. However, print jobs may be received from external sources.

The print engine is generally to print images of print jobs. The fuser, which may include heated rollers, is generally to heat paper onto which toner powder has been deposited in the form of an image being printed (e.g., as acquired by the scan engine and/or received from an external source), and the fuser further heats the toner powder to fuse the toner powder to the paper. In general the fuser takes a time period to heat up to the fusing temperature prior to the print engine printing the image of the print job, but a time period to heat to a fusing temperature may depend on ambient temperature at the device.

As such, the device further comprises an ambient temperature sensor, for example to measure ambient temperature at the device internal or external to the device. A time period that the fuser takes to heat to the fusing temperature is generally understood to further depend on various factors associated with cooling of the fuser, such as a time period since a last print job, or a temperature change of the fuser since a last print job (e.g., in these examples, the device includes a fuser temperature sensor). For example, a time period to heat the fuser to the fusing temperature may increase as the time period since a last print job increases, or as the fuser cools downs (e.g., a temperature change since a last print job increases). However, a relationship between a time period that the fuser takes to heat to the fusing temperature, and various factors associated with cooling of the fuser, generally depends on the ambient temperature (e.g., and/or a fusing temperature and/or a scanner temperature). For example, in hotter climates and/or for hotter ambient temperatures, a time period that the fuser takes to heat to the fusing temperature may be less than for cooler climates and/or for cooler ambient temperatures.

As such, the device further includes a memory storing a plurality of curves that relate, for given respective ambient temperatures, respective time periods for the fuser to heat to a fusing temperature, to respective factors associated with cooling of the fuser. Such curves may also be for combinations of the given respective ambient temperatures and for: given respective fusing temperatures (e.g., in these examples, the device includes a fuser temperature sensor), given respective scan engine temperatures (e.g., in these examples, the device includes a scan engine and a scan engine temperature sensor), or a combination. In examples where such curves relate, for given respective ambient temperatures, respective time periods for the fuser to heat to a fusing temperature, to respective factors associated with cooling of the fuser, the device detects a current ambient temperature using the ambient temperature sensor and selects a curve associated with the current ambient temperature. However, the device may select a curve based on the current ambient temperature and any suitable combination of a current fuser temperature and a current scan engine temperature.

The device determines a current factor associated with cooling of the fuser, such as a time period since a last print job. The device uses the selected curve and the current factor to determine a respective time period to heat the fuser to the fusing temperature, and controls the fuser accordingly.

In examples where the device includes a scan engine, a start time for controlling the fuser to heat to the fusing temperature may be set relative to a scan end time of the scan engine, for example by subtracting the respective time period (determined from the selected curve) from a scan end time determined from a scan start time and a predetermined scan time period (e.g., a time period for the scan engine to scan a document may be generally known).

While such examples are described with respect to a scan engine, similar features may be implemented at the device when receiving and/or processing a print job from an external source. For example, a start time for controlling the fuser to heat to the fusing temperature may be set relative to an end printing job processing time (e.g., by a processor of the device), for example by subtracting the respective time (determined from the selected curve) from an end printing job time determined from a start printing job time and a given printing job time period (e.g., a time period for the processor to process a print job may be generally known).

In some examples, the device may further be provided with an initial (e.g., factory generated) curve that is independent of ambient temperature and/or may be for one ambient temperature, the curve relating respective time periods for the fuser to heat to a fusing temperature, to respective factors associated with cooling of the fuser. However, such an initial curve may not be accurate for the environmental conditions which the device experiences outside of the factory. As such, the device may be to generate additional curves by determining ambient temperature and the respective factors associated with cooling of the fuser for various scan jobs and/or print jobs, and further determining time differences between scan end times that the scan engine stops scanning (and/or end print job processing times) and a print start time the print engine starts printing. The device may store, at the memory, the current ambient temperatures in association with respective indications of the respective time differences and the respective current factors, the respective indications to adjust a start time for heating the fuser for a later print job at the current ambient temperature. For example, such data may be used to generate additional curves, for respective ambient temperatures, to later coordinate controlling the fuser to heat to a fusing temperature with a scan end time of the scanning engine (and/or end print job processing times) such that, when the scan engine has completed scanning, the fuser, and the print engine, are ready to print a print job generated by the scan engine (and/or a print a print job received from an external source).

In yet further examples, there may be no initial curve provided with the device, and the device may generate the aforementioned plurality of curves. In yet further examples, the device may measure ranges of ambient temperatures experienced by the device in an environment in which the device is installed, and download the aforementioned plurality of curves for the range of temperatures. Such a plurality of curves may be generated by similar devices and uploaded to central storage device (e.g., such as cloud storage device) for download. In yet further examples, the device may generate such a plurality of curves and upload the curves to the central storage device (for download by similar devices.

An aspect of the present specification provides a device comprising: a print engine including a fuser; an ambient temperature sensor; a memory storing a plurality of curves that relate, for given respective ambient temperatures, respective time periods for the fuser to heat to a fusing temperature, to respective factors associated with cooling of the fuser; and a processor to, for a print job for the print engine: detect a current ambient temperature using the ambient temperature sensor; select a curve, from the plurality of curves, using the current ambient temperature; determine a current factor associated with cooling of the fuser; and control the fuser to heat to the fusing temperature based on a respective time period determined from the curve and the current factor associated with cooling of the fuser.

Another aspect of the present specification provides a method comprising, at a device that includes a scan engine, a print engine, and an ambient temperature sensor: determining a current ambient temperature using the ambient temperature sensor; determining when the scan engine begins to scan; controlling a fuser of the print engine to begin heating to a fusing temperature at a start time, set relative to an scan end time of the scan engine, and determined from: a curve, associated with the current ambient temperature, that relates a time period for the fuser to heat to the fusing temperature, to a factor associated with cooling of the fuser; and a current factor associated with cooling of the fuser.

Another aspect of the present specification provides a non-transitory computer-readable medium comprising instructions that, when executed by a processor of a device that includes a scan engine, a print engine, and an ambient temperature sensor, causes the processor to: determine a current ambient temperature using the ambient temperature sensor; determine when the scan engine begins to scan to generate a print job; determine a current factor associated with cooling of a fuser of the print engine; control the fuser to heat to a fusing temperature, to print the print job from the scan engine; determine a time difference between a scan end time that the scan engine stops scanning and a fuser heating end time at which the fuser reaches the fusing temperature; and store, in a memory, the current ambient temperature in association with indications of the time difference and the current factor, the indications to adjust a start time for heating the fuser for a later print job at the current ambient temperature.

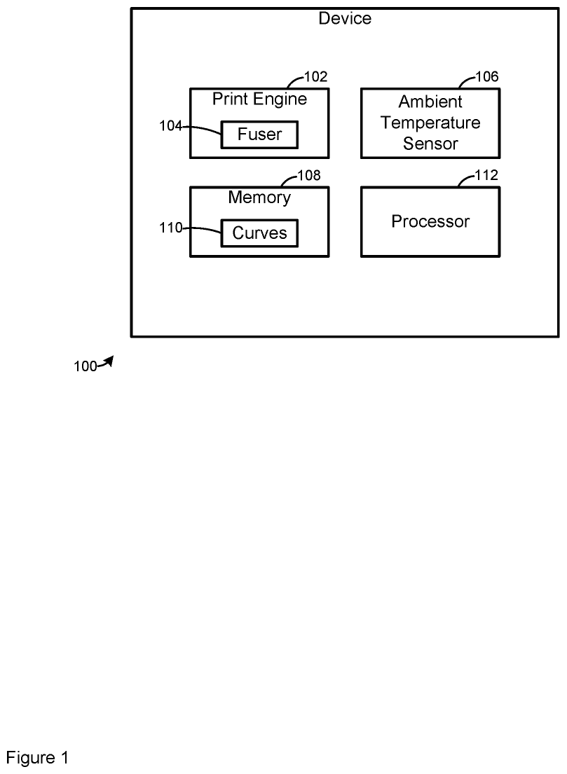

Attention is first directed to FIG. 1, which is a block diagram of an example device 100 to control a print engine based on ambient temperatures.

The device 100 may comprise a printer, a laser printer, and the like, and/or any suitable device which incorporates a print engine as described herein. Hence, the device 100 generally comprises a print engine 102 that includes a fuser 104. The print engine 102 is understood to comprise any suitable combination of hardware and software components (e.g., the software components implemented by a processor 112, described below, or another processor) that implements the functionality of the print engine 102. In particular, the print engine 102 may generally include any suitable components for printing images of print jobs, such as lasers, toner cartridges, and the like. In general, the print engine 102 deposits toner onto paper in the form of an image to be printed (e.g., as generated from a scan engine, or received from an external source). As used herein, the term “print job” is understood to include data representing images to be printed, the data being in any suitable format and generated by the device 100 and/or received by the device 100 in any suitable manner; hence, “images” of print jobs are understood to include images represented by data of such print jobs. As such, hereafter the device 100 and/or the print engine 102 may be described as printing a print job, and such printing of a print job is understood to include printing images of the print job.

The fuser 104 may include heated rollers, and the fuser 104 may also include a heater to heat the rollers. The heated rollers may be to fuse the toner to the paper moving through the rollers to set the image onto the paper. In general, to sufficiently adhere and/or fuse the toner to the paper, the fuser 104 is generally to sufficiently heat the relevant components to a fusing temperature, which is generally predetermined. Hereafter, the fuser 104 is described as being controlled to heat to a fusing temperature, which is understood as controlling a heater of the fuser 104, and/or rollers of the fuser 104, to heat to the fusing temperature. It is further understood that heating to the fusing temperature takes time, which is referred to hereafter as a time period to heat the fuser 104 to the fusing temperature. Such a time period may vary depending on environmental conditions at the device, including, but not limited to, ambient temperature.

As such, the device 100 further comprises an ambient temperature sensor 106 to measure ambient temperature external to the device 100 and/or internal to the device 100. The ambient temperature sensor 106 may comprise any suitable temperature sensor (e.g., a thermocouple, a resistive temperature Device (RTD), a thermistor, an integrated silicon based sensor, and the like) located in any suitable location at the device 100 to generally measure ambient temperatures, which may affect a time period for the fuser 104 to heat to a fusing temperature.

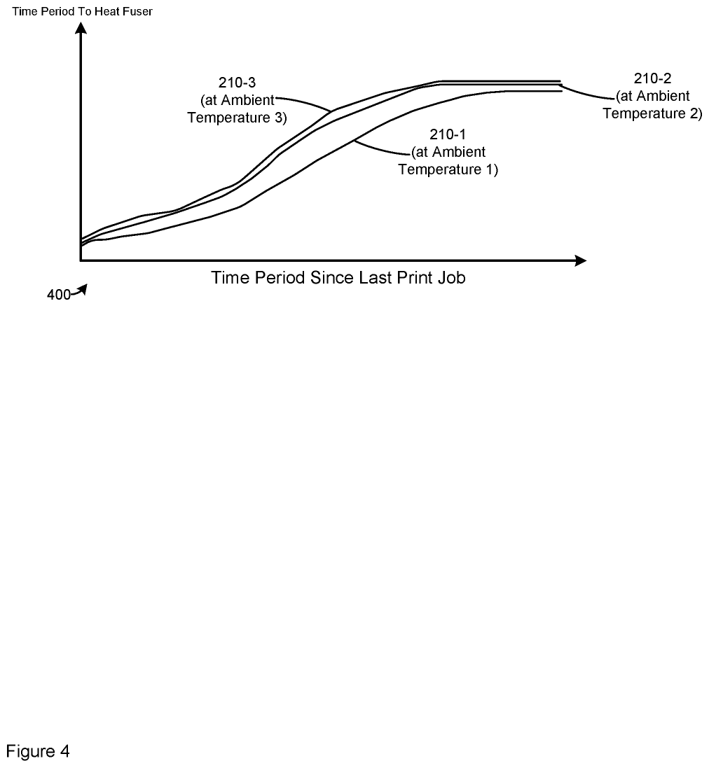

The device 100 further comprises a memory 108 storing a plurality of curves 110. While described in further detail below (e.g., see FIG. 4), the curves 110 generally relate, for given respective ambient temperatures, respective time periods for the fuser 104 to heat to the fusing temperature, to respective factors associated with cooling of the fuser 104. Such factors may include, but are not limited to, a time period since a last print job, a temperature change of the fuser 104 since a last print job, and the like. When the factors include a temperature change of the fuser 104 since a last print job, the device 100, and/or the print engine 102, is understood to include a fuser temperature sensor.

In general, a given curve 110 represents, for an associated temperature, a relationship between a time period for the fuser 104 to heat to the fusing temperature and cooling of the fuser 104 since a last print job. Hence, for example, a given curve 110 may, for an associated temperature, relate a time period for the fuser 104 to heat to the fusing temperature to a time period since a last print job.

While the curves 110 are described herein with respect to graphs and/or graphic representations thereof (e.g., see FIG. 4), the curves 110 may be provided in the form of tables and/or lookup tables, and/or in a database format and/or as a mathematical functions.

As depicted, the device 100 further comprises a processor 112 to detect a current ambient temperature using the ambient temperature sensor 106; select a curve 110, from the plurality of curves 110, using the current ambient temperature; determine a current factor associated with cooling of the fuser 104; and control the fuser 104 to heat to the fusing temperature based on a respective time period determined from the curve 110 (e.g., as selected using the current ambient temperature) and the current factor associated with cooling of the fuser 104.

Hence, in general, when the device 100 is to print a print job, which may be generated using a scan engine (not depicted) and/or may be received from an external source (e.g., via a communication interface and/or a wired and/or wireless communication link, not depicted), then the device 100 may determine a time period to heat the fuser 104 to the fusing temperature from a curve 110, and control the fuser 104 to start heating (e.g., at a fuser heating start time) such that the fuser 104 reaches the fusing temperature, in the determined time period, when the device 100 has finished generating the print job (e.g., the scan engine has finished a scan job and/or the processor 112 has finished processing a received print job) and the print job is ready to be printed.

An example is next described with respect to a print job generated by a scan engine of the device 100. In general, scan engines generally have a predetermined scan time period, which may be stored at the memory 108. As such, the processor 112 may generally determine a scan end time from a scan start time. The processor 112 may subtract the determined time period (e.g., for the fuser 104 to heat to the fusing temperature) from a scan end time so that, when the scan engine has completed scanning (e.g., a document), the fuser 104 has just reached the fusing temperature, and hence there is no delay in printing the print job from the scan engine. Further, neither does the fuser 104 reach the fusing temperature before the scan engine has completed scanning, which saves wear and tear on components of the print engine 102 and/or the fuser 104.

In general, the processor 112 is further to determine a time of a print job printed by the print engine 102 (e.g., a last time that a heater of the fuser 104 was turned off which may correspond to a time that the print engine 102 completed a print job), a time period since the last print job (e.g., a time period since a heater of the fuser 104 was turned off may correspond to a time period since the print engine 102 completed a print job), and the like. As such, the device 100 may further comprise a clock, and the like, which may comprise a clock of the processor 112 (e.g., the processor 112 may comprise a clock, or a clock may be external to the processor 112).

In examples, where the respective factors of the curves 110, associated with cooling of the fuser 104, comprises a temperature change of the fuser 104 since a last print job, the device 100 and/or the print engine 102 and/or the fuser 104 is understood to include a fuser temperature sensor (not depicted). Furthermore, in these examples, the processor 112 may be further to determine a temperature of the fuser 104 when a last print job ended (e.g., temperature measured by the fuser temperature sensor a last time that a heater of the fuser 104 was turned off), a temperature change of the fuser 104 since a last print job (e.g., a current temperature measured by the fuser temperature sensor as compared to the temperature measured by the fuser temperature sensor a last time that a heater of the fuser 104 was turned off), and the like. Hence, in these examples, the processor 112 is further to determine the current factor associated with cooling of the fuser 104 by: determining, using the fuser temperature sensor, a current temperature change of the fuser 104 since a last respective print job.

In some examples, the device 100 may further comprise a fuser temperature sensor, a scan engine temperature sensor or a combination. In some of these examples, the plurality of curves 110 may be for combinations of the given respective ambient temperatures (e.g., measured by the ambient temperature sensor 106) and for: given respective fuser temperatures (which may be less than the fusing temperature, or at the fusing temperature), given respective scan engine temperatures, or a combination. Put another way, the curves 110 may be for combinations of ambient temperatures and fuser temperatures, combinations of ambient temperatures and scan engine temperatures, or combinations of ambient temperatures, fuser temperatures and scan engine temperatures. In other words, a time period to heat the fuser 104 to the fusing temperature may depend not only on ambient temperatures, but also fuser temperature and/or a scan engine temperature. Put another way, a time period to heat the fuser 104 to the fusing temperature generally depends on environmental factors at the device 100, which may be represented by ambient temperatures, as well as fuser temperatures and/or scan engine temperatures, and the curves 110 may be provided accordingly. In these examples, the processor 112 may be further to select a curve 110, from the plurality of curves 110, using the combination of the current ambient temperature and: a current fuser temperature determined using the fuser temperature sensor, a current sensor temperature determined using the sensor temperature sensor, or a combination.

As previously mentioned herein, in some examples, the device 100 may further comprise a scan engine having a predetermined scan time period. The scan engine may be to scan documents, and the predetermined scan time period may depend on a resolution of scan, which may be predetermined and/or selected via an input device of the device 100. In these examples, the processor 112 may be further to control the fuser 104 to heat to the fusing temperature based on respective time period (e.g., determined from a selected curve 110) by: determining a scan start time when the scan engine begins to scan; and controlling the fuser 104 to heat to the fusing temperature at a time corresponding to subtracting the respective time period from a scan end time determined from the scan start time and the predetermined scan time period.

However, in other examples, the device 100 may further comprise a communication interface to receive print jobs from external sources, and the processor 112 may process such print jobs according to a predetermined print job processing time period. In these examples, the processor 112 may be further to control the fuser 104 to heat to the fusing temperature based on respective time period (e.g., determined from a selected curve 110) by: determining a print job processing start time when the processor 112 begins to process a received print job; and controlling the fuser 104 to heat to the fusing temperature at a time corresponding to subtracting the respective time period from a print job processing end time determined from the print job processing start time and the predetermined print job processing time period.

The processor 112 is understood to be communicatively coupled, as suitable, to other components of the device 100 such that processor 112 may transmit control commands to the components (e.g., to control the print engine 102 and/or the fuser 104) and/or receive information therefrom, such as the curves 110 from the memory 108 and/or current ambient temperatures from the ambient temperature sensor 106, and the like. The processor 112 may include a central processing unit (CPU), a microcontroller, a microprocessor, a processing core, a field-programmable gate array (FPGA), an application specific integrated circuit (ASIC), or similar, or a combination. The processor 112 and memory 108 may cooperate to execute various instructions (e.g., such as instructions (not depicted) stored at the memory 108, which, when executed by the processor 112, implements functionality as described herein).

The memory 108 is coupled to the processor 112 and may include a non-transitory machine-readable storage medium that may be any electronic, magnetic, optical, or other physical storage device. The non-transitory machine-readable storage medium of the memory 108 may include, for example, random access memory (RAM), electrically-erasable programmable read-only memory (EEPROM), flash memory, a storage drive, an optical disc, and the like. The memory 108 may also be encoded with executable instructions to operate the print engine 102 and/or the fuser 104 (and a scan engine when present) and/or and other hardware in communication with the processor 112.

The memory 108 may also store an operating system that is executable by the processor 112 to provide general functionality to the device 100, for example, functionality to support various applications such as a user interface to access various features of the device 100. Examples of operating systems include a Real-Time Operating System (RTOS). Windows™, macOS™, IOS™, Android™, Linux™, and Unix™. The memory 108 may additionally store applications that are executable by the processor 112 to provide specific functionality to the device 100.

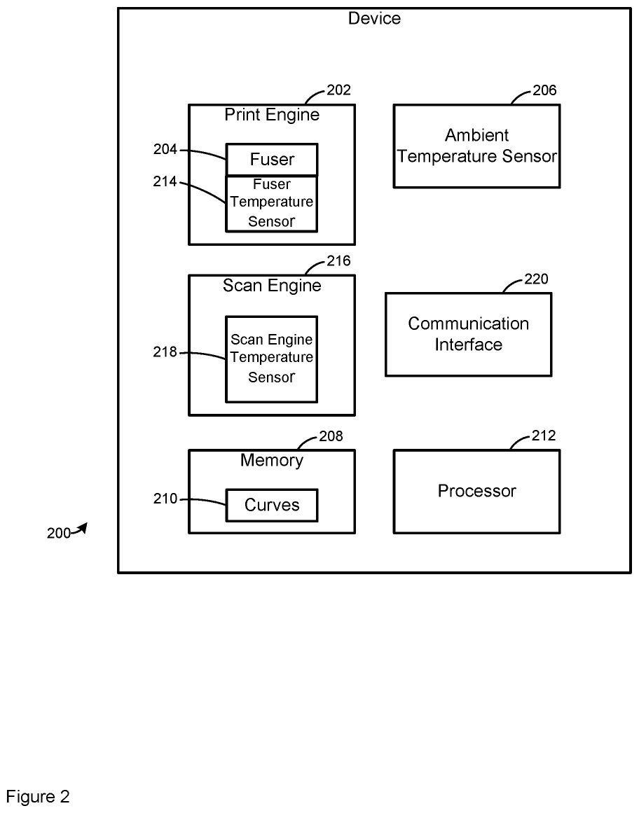

Attention is next directed to FIG. 2 which depicts another example device 200 to control a print engine based on ambient temperatures. The device 200 is substantially similar to the device 100, with like components having like numbers, but in a “200” series” rather than a “100” series. Hence, as depicted, the device 200 comprises a print engine 202 that includes a fuser 204, an ambient temperature sensor 206, a memory 208 storing curves 210, and a processor 212 that are respectively similar to the print engine 102, the fuser 104, the ambient temperature sensor 106, the memory 108, the curves 110, and the processor 112.

However, the device 200 further includes a fuser temperature sensor 214, a scan engine 216, a scan engine temperature sensor 218 and a communication interface 220.

As depicted, the fuser temperature sensor 214 is located at the print engine 202, and/or the fuser 204, to measure fuser temperature. Similarly, the scan engine temperature sensor 218 is located at the scan engine 216 to measure scan engine temperature. The sensors 214, 218 may be otherwise similar to the ambient temperature sensor 206. Further, the ambient temperature sensor 206 may be located at distances from the print engine 202 and/or the scan engine 216 such that temperature measured by the ambient temperature sensor 206 comprises an ambient temperature, though the ambient temperature measured by the ambient temperature sensor 206 is understood to be local to, and/or proximal to, the device 200, and may, in some examples, be affected by heat emitted from the print engine 202 and/or the scan engine 216

The scan engine 216 is understood to comprise any suitable combination of hardware and software components (e.g., the software components implemented by the processor 212, or another processor) to scan documents, and the like, to generate print jobs that include images to be printed by the print engine 202. The scan engine 216 may hence include a flatbed scanner, a sheetfeed scanner, among other possibilities. Regardless of a configuration of the scan engine 216, the processor 212 is generally enabled to determine a scan start time of the scan engine 216 (e.g., a time that scanning of a document begins) and further has access to a predetermined scan time period (e.g., which may be stored at the memory 208).

The communication interface 220 may comprise any suitable combination of wireless transceivers and/or wired transceivers, and the like to communicate with external sources of print jobs, via any suitable combination of wireless communication links and/or wired communication links. Hence, via the communication interface 220, the device 200 may wirelessly receive, and/or receive via wires, print jobs from external sources, such as personal computers and/or laptops, servers, cloud computing devices, and the like.

As has been previously described, the processor 212 may be generally to control the fuser 204 to heat to a fusing temperature at a time corresponding to subtracting a respective time period (e.g., determined from a curve 210 selected using a current ambient temperature determined by the ambient temperature sensor 206) from a scan end time determined from a scan start time and the predetermined scan time period.

Similarly, as has been previously described, the processor 212 may be generally to control the fuser 204 to heat to a fusing temperature at a time corresponding to subtracting a respective time period (e.g., determined from a curve 210 selected using a current ambient temperature determined by the ambient temperature sensor 206) from a processing print job end time determined from a processing print job start time and the predetermined processing print job time period.

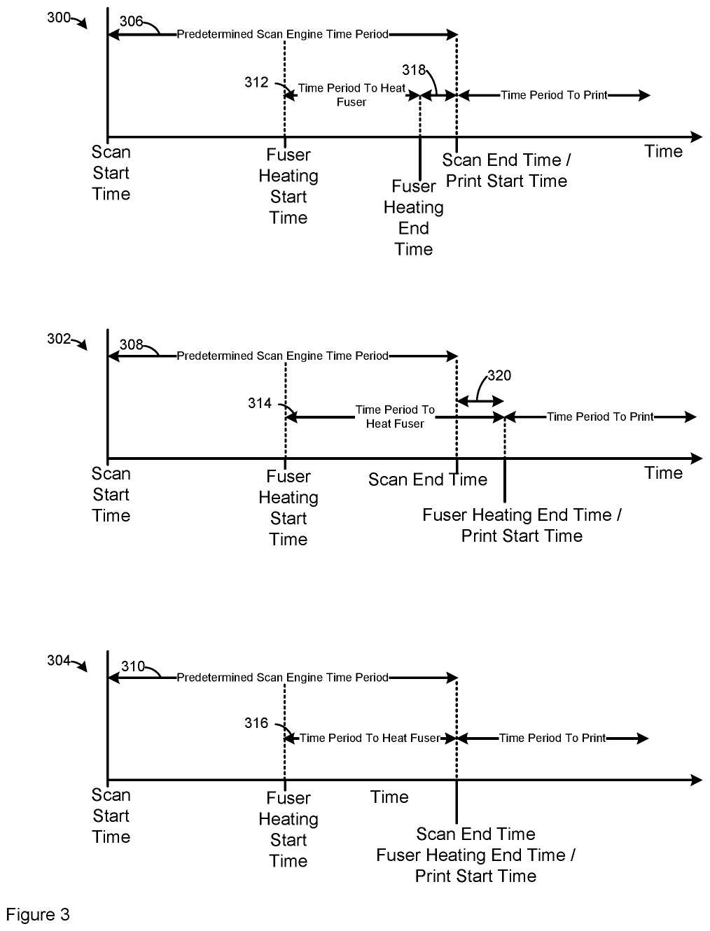

Attention is next directed to FIG. 3 which depicts example timing diagrams 300, 302, 304 of the scan engine 216 and the print engine 202 to scan a document to generate an image of a print job, and to print the image of the print job. However, similar timing diagrams may be used to describe timing between the processor 212 processing a received print job and the print engine 202.

A timing diagram 300, 302, 304 generally shows a respective line 306, 308, 310 along a time axis (e.g., labelled “Time”), that shows a scan start time and a predetermined scan engine time period, which respectively indicate a start time that the scan engine 216 starts scanning, and a predetermined time period that the scan engine 216 takes to perform a scan. The predetermined scan engine time period may be determined at a factory and stored at the memory 208 (and may depend on a resolution of a scan, and hence the memory 208 may store a plurality of predetermined scan engine time periods for scans depending on resolution, and may select a scan engine time period for a scan accordingly).

Hence, a timing diagram 300, 302, 304 also indicates a stop scan time at a line 306, 308, 310, which is the scan start time plus the predetermined scan engine time period added thereto.

A timing diagram 300, 302, 304 generally shows a respective line 312, 314, 316 along the time axis, that shows a start time that the fuser 204 may begin heating (“Fuser Heating Start Time”), a time period for the fuser 204 to reach the fusing temperature (e.g., “Time Period To Heat Fuser”), and a time period for the print engine 202 to print an image of a print job (e.g., “Time Period To Print”).

Also indicated at the lines 312, 314, 316 are a fuser heating end time (e.g., “Fuser Heating End Time”, which is at an end of a time period for the fuser 204 to reach the fusing temperature, and a print start time (e.g., “Print Start Time”). A print start time may comprise a time at which paper begins moving through the heater rollers of the fuser 204 (e.g., and/or a time at which the heated rollers begin rolling to move the paper therethrough). While the time period that the fuser 204 reaches a fusing temperature is labelled “Fuser Heating End Time”, it is understood that the fuser 204 is controlled to stay at the fusing temperature from the fuser heating end time to an end of the time period for the print engine 202 to print an image of a print job. Put another way, during the time period for the print engine 202 to print an image of a print job, the fuser 204 remains at the fusing temperature, and after the time period for the print engine 202 to print an image of a print job, the processor 212 may control the fuser 204 to stop heating. A time period since a last print job may be determined from a time that the processor 212 controls the fuser 204 to stop heating.

At the timing diagram 300, the fuser heating end time does not align with the scan end time. In particular, the fuser heating end time occurs before the scan end time and the line 312 includes a time period 318 during which the fuser 204 is at the fusing temperature, but the print engine 202 is not printing. Rather, the print engine 202 waits for the scan engine 216 to complete scanning, and then begins printing an image from the print job generated by the scan engine 216. As such, at the timing diagram 300, the scan end time and the print end time are aligned, but energy is wasted during the time period 320, and which may place unnecessary wear and tear on components of the print engine 202.

Similarly, at the timing diagram 302, the fuser heating end time also does not align with the scan end time. In particular, the fuser heating end time occurs after the scan end time. Hence, the scan engine 216 completes scanning, but the print engine 202 waits for the fuser 204 to reach the fuser temperature (e.g., by a time period 320), then begins printing an image from the print job generated by the scan engine 216. As such, at the timing diagram 302, the fuser heating end time and the print end time are aligned, printing of the print job is delayed, for example by the time period between the scan end time and the fuser heating end time.

Put another way, a time period for the fuser 204 to heat to a fusing temperature may vary with ambient temperature and/or other environmental conditions. For example the time period for the fuser 204 to heat to a fusing temperature is shorter in the timing diagram 300 as compared to the timing diagram 302. Hence, when the device 200 relies on a fixed time period to heat the fuser 204, but the time period varies, wear and tear may occur at the device 200 when the fuser 204 reaches the fusing temperature before scanning is completed (e.g., as in timing diagram 300), or a delay in printing may occur at the device 200 when the fuser 204 reaches the fusing temperature after scanning is completed (e.g., as in timing diagram 302).

Indeed, ideally, the scan end time, the fuser heating end time, and the print start time are aligned as shown in the timing diagram 304. As such, the device 200 and/or the processor 212 is generally configured to determine, from the curves 210, a time period for the fuser 204 to heat to the fusing temperature. A scan end time may be determined from a scan start time and the predetermined scan engine time period, and hence the fuser heating time may be determined from the time period for the fuser 204 to heat to the fusing temperature subtracted from the scan end time, to generally align the scan end time, the fuser heating end time, and the print start time.

As mentioned above, similar timing diagrams may be used to describe timing between the processor 212 processing a received print job and the print engine 202. In such examples, the timing diagrams 300, 302, 304 may be modified to show a predetermined print job processing time period (e.g., in place of a predetermined scan engine time period), a print job processing start time (e.g., in place of a scan start time), and a print job processing end time (e.g., in place of a scan end time). The timing problems between processing print jobs by the processor 212, heating of the fuser 204 and printing by the print engine 202 are otherwise similar to as described with respect to the scan engine 216 generating print jobs.

Attention is next directed to FIG. 4 which depicts a graph 400 showing examples of the curves 210 at three different ambient temperatures. For example, a curve 210-1 may be for an Ambient Temperature 1, a curve 210-2 may be for an Ambient Temperature 2, and a curve 210-3 may be for an Ambient Temperature 3.

The abscissa (i.e. “X” axis) of the graph 400 is a time period since a last print job, and the ordinate (i.e. “Y” axis) of the graph is for a time period for the fuser 104 to heat to the fusing temperature. Hence, in the example in FIG. 4, the curves 210 relate, for an associated ambient temperature, a time period for the fuser 204 to heat to the fusing temperature, to a factor associated with cooling of the fuser 204, as depicted a time period since a last print job. Alternatively, the curves 210 may be for a temperature change of the fuser 204 since a last print job, as measured using the fuser temperature sensor 214 (e.g., with the abscissa of the graph 400 adapted accordingly).

As is apparent from the curves 210, for different ambient temperatures, a shape of the curves 210 varies, and hence, for different ambient temperatures, a relationship between a time period for the fuser 104 to heat to the fusing temperature, and the time period since a last print job, varies. For example, the Ambient Temperature 1 may be higher than the Ambient Temperature 2, and hence, for a given time period since a last print job, a time period for the fuser 104 to heat to the fusing temperature is less for the Ambient Temperature 1 than the Ambient Temperature 2.

While not depicted, the depicted curves 210 may be for combinations of a respective ambient temperature, and a fuser temperature and/or a scan engine temperature. In such examples, the curves 210 may be components of three-dimensional surfaces that relate time period for the fuser 104 to heat to the fusing temperature to ambient temperature, and fuser temperature and/or scan engine temperature.

Furthermore, in some examples, the curves 210 may comprise offsets from a “standard” and/or factory determined curve that relates, for a generic ambient temperature, a time period for the fuser 204 to heat to the fusing temperature, to a factor associated with cooling of the fuser 204. Put another way, rather than the ordinate of graph 400 comprising a time period to heat the fuser 204 to the fusing temperature, the ordinate of graph 400 may comprise a difference (e.g., an offset) between a time period to heat the fuser 204 to the fusing temperature and a time period for the fuser 204 to heat to the fusing temperature defined by a “standard” curve.

Attention is next directed to FIG. 4, which shows a flowchart of an example method 500 to control a print engine based on ambient temperatures. In order to assist in the explanation of method 500, it will be assumed that method 500 may be performed using the device 200, and/or the processor 212 thereof implementing the method 500. Indeed, the method 500 may be one way in which the device 200 may be configured. Furthermore, the following discussion of method 500 may lead to a further understanding of the device 200, and its various components. Furthermore, it is to be emphasized, that method 500 may not be performed in the exact sequence as shown, and various blocks may be performed in parallel rather than in sequence, or in a different sequence altogether. The method 500 may also be implemented by the device 100 and/or the processor 112 thereof.

Ata block 502, the device 200 and/or the processor 212 determines a current ambient temperature using the ambient temperature sensor 206.

For example, the processor 212 may periodically read the current ambient temperature from the ambient temperature sensor 206 and/or the processor 212 may read the current temperature from the ambient temperature sensor 206 when the scan engine 216 begins to scan, which may correspond to an input device at the device 200 being actuated.

At a block 504, the device 200 and/or the processor 212 determines when the scan engine 216 begins to scan.

For example, the scan engine 216 may begin to scan when an input device at the device 200 is actuated and/or after a time period after such an input device is actuated and/or when a light of the scan engine 216 turns on, and the like. However, any suitable process for determining when the scan engine 216 begins to scan is within the scope of the present specification, and a predetermined scan time period is understood to begin from any suitable corresponding start time. In particular, with reference to FIG. 3, the scan engine 216 is understood to start scanning at a “Scan Start Time”.

At a block 506, the device 200 and/or the processor 212 controls the fuser 204 of the print engine 202 to begin heating to a fusing temperature at a start time, set relative to a scan end time of the scan engine 216. In particular, with reference to FIG. 3, the fuser 204 is understood to begin heating at a “Fuser Heating Start Time”. The start time of the fuser 204 to begin heating to the fusing temperature is understood to be determined from: a curve 210, associated with the current ambient temperature. Such a curve 210, as has been previously described, relates a time period for the fuser 204 to heat to the fusing temperature, to a factor associated with cooling of the fuser 204; and a current factor associated with cooling of the fuser 204.

Hence, at the block 506 and/or prior to the block 506, the device 200 and/or the processor 212 may further select a curve 210 based on the ambient temperature determined at the block 502, determine a factor associated with cooling of the fuser 204, such as a time period since a last print job, and determine the time period for the fuser 204 to heat to the fusing temperature accordingly from the selected curve 210.

Further, the start time of the fuser 204 to begin heating to the fusing temperature may be determined by subtracting the time period for the fuser 204 to heat to the fusing temperature, as determined using the selected curve 210, from the scan end time. The timing diagram 304 represents such an example such that the scan end time, the fuser heating end time and the print start time are aligned.

However, in some instances, a selected curve 210 may be inaccurate; for example, environmental conditions at the device 100 may have changed. Regardless, in some examples, the fuser heating end time, at which the fuser 104 reaches the fusing temperature, may not correspond to the scan end time (e.g., as in timing diagrams 300, 302).

Hence, as depicted, at a block 508, the device 200 and/or the processor 212 determines whether the fuser heating end time, at which the fuser 104 reaches the fusing temperature corresponds, or does not correspond, to the scan end time. In response to determining that the fuser heating end time at which the fuser 104 reaches the fusing temperature does not correspond to the scan end time of the scan engine 216 (e.g., a “YES” decision at the block 508), at a block 510, the device 200 and/or the processor 212 adjusts the curve 210 (e.g., selected at the block 506) to account for a difference between the fuser heating end time and the scan end time. In some examples, as depicted, the device 200 and/or the processor 212 may continue implementing the method 500 from the block 502 after the block 510, which is now described in more detail.

For example, at the block 510, in response to determining that a fuser heating end time at which the fuser 204 reaches the fusing temperature is before the scan end time of the scan engine 216 (e.g., as depicted in the timing diagram 300), the device 200 and/or the processor 212 adjusts the curve 210 (e.g., selected at the block 506) to reduce the time period for the fuser 204 to heat to the fusing temperature for the current factor associated with cooling of the fuser 204.

Put another way, the curve 210 selected at the block 506 may have resulted in a time period to heat the fuser 204 to the fusing temperature that was shorter than that determined from the curve 210, as depicted at the timing diagram 300 (e.g., the actual a time period to heat the fuser 204 to the fusing temperature is less than that determined using the selected curve 210). As such, at the block 510, for the selected curve 210, the device 200 and/or the processor 212 reduces (e.g., by the time period 318) the time period for the fuser 204 to heat to the fusing temperature for the current factor associated with cooling of the fuser 204. Hence, when a same current factor associated with cooling of the fuser 204 is determined, for a same ambient temperature, the updated time period for the fuser 204 to heat to the fusing temperature may be used.

Similarly, in response to determining that a fuser heating end time at which the fuser 204 reaches the fusing temperature is after the scan end time of the scan engine 216 (e.g., as depicted at the timing diagram 302), the device 200 and/or the processor 212 adjusts the curve 210 (e.g., selected at the block 506) to increase the time period for the fuser 204 to heat to the fusing temperature for the current factor associated with cooling of the fuser 204.

Put another way, the curve 210 selected at the block 506 may have resulted in a time period to heat the fuser 204 to the fusing temperature that was longer than that determined from the curve 210, as depicted at the timing diagram 302 (e.g., the actual a time period to heat the fuser 204 to the fusing temperature is more than that determined using the selected curve 210). As such, at the block 510, for the selected curve 210, the device 200 and/or the processor 212 increases (e.g., by the time period 320) the time period for the fuser 204 to heat to the fusing temperature for the current factor associated with cooling of the fuser 204. Hence, when a same current factor associated with cooling of the fuser 204 is determined, for a same ambient temperature, the updated time period for the fuser 204 to heat to the fusing temperature may be used.

In some examples, the method 500 may further comprise the device 200 and/or the processor 212 uploading (e.g., via the communication interface 220) a curve 210 adjusted according to local determinations that a fuser heating end time, at which the fuser 204, reaches the fusing temperature does not correspond to a scan end time of the scan engine 216. For example, the block 508 generally corresponds to a local determination (e.g., at the device 200) that a fuser heating end time, at which the fuser 204, reaches the fusing temperature does not correspond to a scan end time of the scan engine 216. Hence, a curve 210 (e.g., as selected at the block 506), responsively adjusted at the block 510, may be uploaded (e.g., via the communication interface 220) to a server and/or a cloud computing device, and/or a cloud storage device, for download by other devices similar to the device 200. Indeed, the curves 210 may be populated in a similar manner.

For example, the method 500 may further comprise downloading (e.g., via the communication interface 220) a curve 210, a portion of the curves 210, or the plurality of curves 210, that relate, for given respective ambient temperatures, respective times for the fuser 204 to heat to the fusing temperature, to respective factors associated with cooling of the fuser 204. A curve 210 and/or curves 210 may be downloaded (e.g., via the communication interface 220) from the aforementioned server and/or cloud computing device, and/or cloud storage device has previously determined and uploaded by other devices similar to the device 200. Hence, the device 200, and similar devices, deployed across a network and/or to different geographic locations, may locally determine curves 210 and share such curves 210 via the aforementioned server and/or cloud computing device, and/or cloud storage device.

In examples where a print job is received from an external source, for example, via the communication interface 220, the method 500 may be modified accordingly. For example, the block 504 may be modified to the device 200 and/or the processor 212 determining when the device 200 and/or the processor 212 starts processing a received print job. Similarly, the block 506 may be modified to the device 200 and/or the processor 212 controlling the fuser 204 of the print engine 202 to begin heating to a fusing temperature at a start time, set relative to a print job processing end time, and determined from: a curve, associated with the current ambient temperature, that relates a time period for the fuser to heat to the fusing temperature, to a factor associated with cooling of the fuser; and a current factor associated with cooling of the fuser. For example, a fuser start time may be determined by subtracting a time period to heat the fuser 204 to the fusing temperature (e.g., determined from a selected curve 210 and a determined current factor associated with cooling of the fuser 204), from a print job processing end time.

Similarly, the block 508 may be modified to the device 200 and/or the processor 212 determining whether a fuser heating end time corresponds (e.g., a “NO” decision at the block 508), or not (e.g., a “YES” decision at the block 508), to a print job processing end time. Similarly, the block 510 may be modified to the device 200 and/or the processor 212 adjusting a selected curve 210 to account for a difference between the fuser heating end time and the print job processing end time.

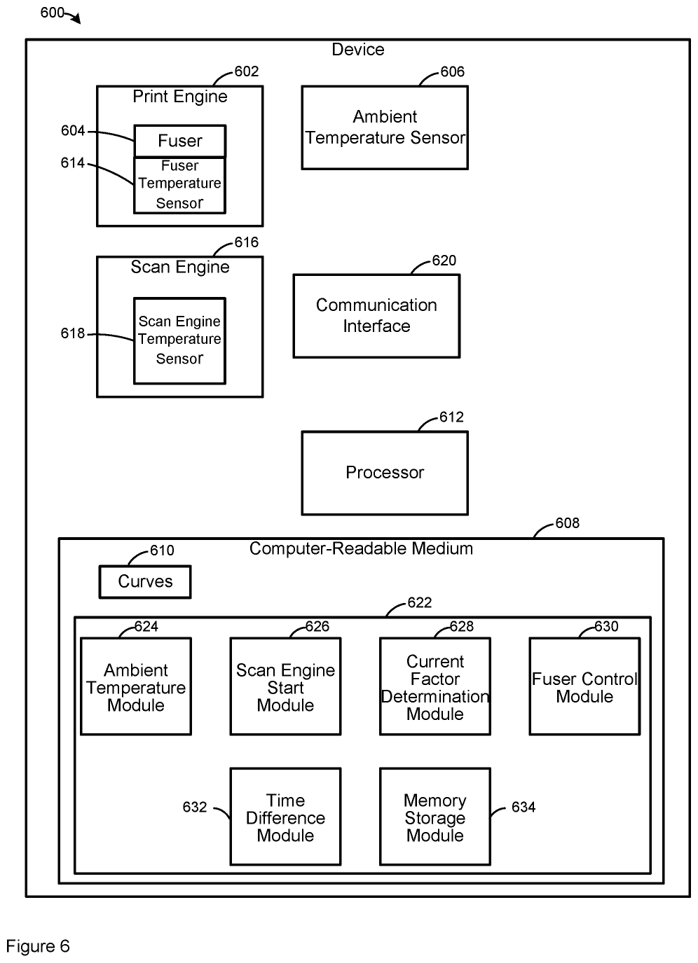

Attention is next directed to FIG. 6, which depicts a block diagram of another example device 600 to control a print engine based on ambient temperatures. In particular, the example device 600 may be to generate and/or adjust curves similar to the curves 110, 210, and the like.

The device 600 is substantially similar to the device 200, with like components having like numbers, but in a “600” series” rather than a “200” series. Hence, as depicted, the device 600 comprises a print engine 602, a fuser 604, an ambient temperature sensor 606, a non-transitory computer-readable memory 608, which may store curves 610 and/or which may initially not store the curves 610, a processor 612, a fuser temperature sensor 614, a scan engine 616, a scan engine temperature sensor 618 and a communication interface 620 that are respectively similar to the print engine 202, the fuser 204, the ambient temperature sensor 206, the memory 208, the curves 210, the processor 212, the fuser temperature sensor 214, the scan engine 216, the scan engine temperature sensor 218 and the communication interface 220.

The computer-readable medium 608 further includes instructions 622 that, when implemented by the processor 612, cause the processor 612 to control the print engine 602 based on ambient temperatures.

Similar to the memory 208, the computer-readable medium 608 may be a non-transitory computer-readable medium, such as a volatile computer-readable medium (e.g., volatile RAM, a processor cache, a processor register, etc.), a non-volatile computer-readable medium (e.g., a magnetic storage device, an optical storage device, a paper storage device, flash memory, read-only memory, non-volatile RAM, etc.), and/or the like.

Similar to the processor 212, the processor 612 may be a general-purpose processor or special purpose logic, such as a microprocessor (e.g., a central processing unit, a graphics processing unit, etc.), a digital signal processor, a microcontroller, an ASIC, an FPGA, a PAL (programmable array logic), a PLA (programmable logic array), a PLD (programmable logic device), etc. The computer-readable medium 608 or the processor 612 may be distributed among a plurality of computer-readable media or a plurality of processors.

The computer-readable medium 608 includes instructions 622, as depicted in the form of modules 624, 626, 628, 630, 632, 634. As used herein, a “module” (e.g., which, in some examples, may be referred to as a “software module”) is a set of instructions that when implemented or interpreted by a processor or stored at a processor-readable medium realizes a component or performs a method and/or causes the processor to implement a certain functionality.

In particular the computer-readable medium 608 includes an ambient temperature module 624, which, when processed by the processor 612, may provide the processor 612 with functionality to determine a current ambient temperature using the ambient temperature sensor 606. For example, the processor 612 may read a current temperature from the ambient temperature sensor 606.

The computer-readable medium 608 further includes a scan engine start module 626, which, when processed by the processor 612, may provide the processor 612 with functionality to determine when the scan engine 616 begins to scan to generate a print job, as has previously been described herein.

The computer-readable medium 608 further includes a current factor determination module 628, which, when processed by the processor 612, may provide the processor 612 with functionality to determine a current factor associated with cooling of the fuser 604 of the print engine 602, as has previously been described herein.

The computer-readable medium 608 further includes a fuser control module 630, which, when processed by the processor 612, may provide the processor 612 with functionality to control the fuser 604 to heat to a fusing temperature, to print the print job from the scan engine 616. In particular, the processor 612 may control the fuser 604 to heat to a fusing temperature based on an initial time period to heat the fuser 604, and the initial time period that may be based on an existing curve 610 and/or may be a generic time period (e.g., provided independent of ambient temperature) initially provisioned at the device 600 (e.g., stored at the instructions 622 and/or the a fuser control module 630 and/or at computer-readable medium 608).

The computer-readable medium 608 further includes a time difference module 632, which, when processed by the processor 612, may provide the processor 612 with functionality to determine a time difference between a scan end time that the scan engine 616 stops scanning and a fuser heating end time at which the fuser 604 reaches the fusing temperature. The processor 612, implementing the time difference module 632, may further determine whether fuser heating end time is before or after the scan end time.

The computer-readable medium 608 further includes a memory storage module 634, which, when processed by the processor 612, may provide the processor 612 with functionality to store, in a memory (e.g., the computer readable medium 608), the current ambient temperature in association with indications of the time difference and the current factor, the indications to adjust a start time for heating the fuser for a later print job at the current ambient temperature.

For example, the indications may comprise a pair of: the time difference (e.g., which may be stored as an offset from the time period initially used by the processor 612 to heat the fuser 604); and the current factor. However, similar to as described with respect to FIG. 4, the indications may comprise a pair of: a time period for the fuser 604 to reach the fusing temperature as initially implemented by the processor 612, but adjusted by the time difference (e.g., to shorten or lengthen the time period depending on whether the fuser heating end time is after or before the scan end time); and the current factor.

Put another way, such indications may be used to generate and/or adjust the curves 610.

For example, the instructions 622, when executed by the processor 612, may further causes the processor 612 to repeatedly implement the modules 624, 626, 628, 630, 632, 634 when a print job is again to be printed, to cause the processor 612 to: repeat, for a plurality of print jobs, determining of a respective current ambient temperature, a respective current factor, and a respective time difference, and storing thereof at the memory to generate the plurality of curves 610 that relate, for given respective ambient temperatures, respective times for the fuser 604 to heat to the fusing temperature, to respective factors associated with cooling of the fuser 604. As such, as print jobs at the device 600 are printed under different environmental conditions, and under different factors related to cooling of the fuser 604, the device 600 builds the curves 610, for example the form of tables and/or lookup tables, and/or in a database format and/or as a mathematical functions. In the example of mathematical functions, the instructions 622, when executed by the processor 612, may further cause the processor 612 to fit a function to the indications as stored the form of tables and/or lookup tables, and/or in a database format, and/or in any other suitable format.

Furthermore, in some examples, the instructions 622, when executed by the processor 612, may further cause the processor 612 to upload the current ambient temperature in association with indications of the time difference and the current factor, for example to a cloud storage device. Such an upload may be in form of the curves 610 and may occur via the communication interface 620.

Similarly, in some examples, the instructions 622, when executed by the processor 612, may further cause the processor 612 to download a plurality of curves 610 (e.g., a portion of the depicted curves 610) that relate, for given respective ambient temperatures, respective times for the fuser 604 to heat to the fusing temperature, to respective factors associated with cooling of the fuser 604 to adjust the start time for heating the fuser 604 for later print jobs at the given respective ambient temperatures. Such a download may be in form of the curves 610 and may occur via the communication interface 620. Furthermore curves 610 downloaded may have been generated by other devices similar to the device 600, and uploaded by such other devices to a cloud storage device.

However, the device 600 may experience only a given range of ambient temperatures in location at which the device 600 is installed. Hence, in some examples, the instructions 622, when executed by the processor 612, may further cause the processor 612 to: measure, over time, a range of ambient temperatures using the ambient temperature sensor 606; and download a plurality of curves 610 that relate, for the range of ambient temperatures, respective times for the fuser 604 to heat to the fusing temperature, to respective factors associated with cooling of the fuser 604 to adjust the start time for heating the fuser 604 for later print jobs in the range of ambient temperatures. In examples where the device 600 is moved to another location with different environmental conditions, the device 600 may continue to measure, over time, a further range of ambient temperatures using the ambient temperature sensor 606; and: delete curves 610 associated with respective ambient temperatures that are not in the further range; or download curves 610 associated with respective ambient temperatures that are in the further range.

It should be recognized that features and aspects of the various examples provided above may be combined into further examples that also fall within the scope of the present disclosure.

1. A device comprising:
a print engine including a fuser;
an ambient temperature sensor;
a memory storing a plurality of curves that relate, for given respective ambient temperatures, respective time periods for the fuser to heat to a fusing temperature, to respective factors associated with cooling of the fuser; and
a processor to, for a print job for the print engine:
detect a current ambient temperature using the ambient temperature sensor;
select a curve, from the plurality of curves, using the current ambient temperature;
determine a current factor associated with cooling of the fuser; and
control the fuser to heat to the fusing temperature based on a respective time period determined from the curve and the current factor associated with cooling of the fuser.

2. The device of claim 1, wherein the respective factors associated with cooling of the fuser comprises a time period since print job.

3. The device of claim 1, further comprising a fuser temperature sensor,
wherein the respective factors associated with cooling of the fuser comprises a temperature change of the fuser since a last print job, and
wherein the processor is further to determine the current factor associated with cooling of the fuser by:
determining, using the fuser temperature sensor, a current temperature change of the fuser since a last respective print job.

4. The device of claim 1, further comprising a fuser temperature sensor, a scan engine temperature sensor or a combination,
wherein the plurality of curves are for combinations of the given respective ambient temperatures and for: given respective fuser temperatures, given respective scan engine temperatures, or a combination, and
wherein the processor is further to select the curve, from the plurality of curves, using the combination of the current ambient temperature and: a current fuser temperature determined using the fuser temperature sensor, a current sensor temperature determined using the sensor temperature sensor, or a combination.

5. The device of claim 1, further comprising a scan engine having a predetermined scan time period,
wherein the processor is further to control the fuser to heat to the fusing temperature based on the respective time period by:
determining a scan start time when the scan engine begins to scan; and
controlling the fuser to heat to the fusing temperature at a time corresponding to subtracting the respective time period from a scan end time determined from the scan start time and the predetermined scan time period.

6. A method comprising, at a device that includes a scan engine, a print engine, and an ambient temperature sensor:
determining a current ambient temperature using the ambient temperature sensor;
determining when the scan engine begins to scan;
controlling a fuser of the print engine to begin heating to a fusing temperature at a start time, set relative to an scan end time of the scan engine, and determined from: a curve, associated with the current ambient temperature, that relates a time period for the fuser to heat to the fusing temperature, to a factor associated with cooling of the fuser; and a current factor associated with cooling of the fuser.

7. The method of claim 6, further comprising, in response to determining that a fuser heating end time at which the fuser reaches the fusing temperature does not correspond to the scan end time of the scan engine:
adjusting the curve to account for a difference between the fuser heating end time and the scan end time.

8. The method of claim 6, further comprising, in response to determining that a fuser heating end time at which the fuser reaches the fusing temperature is before the scan end time of the scan engine:
adjusting the curve to reduce the time period for the fuser to heat to the fusing temperature for the current factor associated with cooling of the fuser.

9. The method of claim 6, further comprising, in response to determining that a fuser heating end time at which the fuser reaches the fusing temperature is after the scan end time of the scan engine:
adjusting the curve to increase the time period for the fuser to heat to the fusing temperature for the current factor associated with cooling of the fuser.

10. The method of claim 6, further comprising:
downloading a plurality of curves that relate, for given respective ambient temperatures, respective times for the fuser to heat to the fusing temperature, to respective factors associated with cooling of the fuser; or
uploading the curve adjusted according to local determinations that a fuser heating end time, at which the fuser reaches the fusing temperature, does not correspond to the scan end time of the scan engine.

11. A non-transitory computer-readable medium comprising instructions that, when executed by a processor of a device that includes a scan engine, a print engine, and an ambient temperature sensor, causes the processor to:
determine a current ambient temperature using the ambient temperature sensor;
determine when the scan engine begins to scan to generate a print job;
determine a current factor associated with cooling of a fuser of the print engine;
control the fuser to heat to a fusing temperature, to print the print job from the scan engine;
determine a time difference between a scan end time that the scan engine stops scanning and a fuser heating end time at which the fuser reaches the fusing temperature; and
store, in a memory, the current ambient temperature in association with indications of the time difference and the current factor, the indications to adjust a start time for heating the fuser for a later print job at the current ambient temperature.

12. The non-transitory computer-readable medium of claim 11, the instructions, when executed by the processor, further causes the processor to:
repeat, for a plurality of print jobs, determining of a respective current ambient temperature, a respective current factor, and a respective time difference, and storing thereof at the memory to generate a plurality of curves that relate, for given respective ambient temperatures, respective times for the fuser to heat to the fusing temperature, to respective factors associated with cooling of the fuser.

13. The non-transitory computer-readable medium of claim 11, the instructions, when executed by the processor, further causes the processor to:
upload the current ambient temperature in association with indications of the time difference and the current factor.

14. The non-transitory computer-readable medium of claim 11, the instructions, when executed by the processor, further causes the processor to:
download a plurality of curves that relate, for given respective ambient temperatures, respective times for the fuser to heat to the fusing temperature, to respective factors associated with cooling of the fuser to adjust the start time for heating the fuser for later print jobs at the given respective ambient temperatures.

15. The non-transitory computer-readable medium of claim 11, the instructions, when executed by the processor, further causes the processor to:
measure, over time, a range of ambient temperatures using the ambient temperature sensor; and
download a plurality of curves that relate, for the range of ambient temperatures, respective times for the fuser to heat to the fusing temperature, to respective factors associated with cooling of the fuser to adjust the start time for heating the fuser for later print jobs in the range of ambient temperatures.
